(19) United States
(12) Patent Application Publication
(10) Pub. No.: US 2023/0148236 A1
(43) Pub. Date: May 11, 2023

(54) ON-DEMAND SERVICE INSTANTIATION

(71) Applicant: Cisco Technology, Inc., San Jose, CA (US)

(72) Inventors: Patrice Brissette, Gatineau (CA); Rakesh Gandhi, Stittsville (CA); Alexander Maria Thuijs, Holliston, MA (US)

(21) Appl. No.: 17/970,077

(22) Filed: Oct. 20, 2022

Related U.S. Application Data
(60) Provisional application No. 63/276,155, filed on Nov. 5, 2021.

(51) Int. Cl. H04L 45/302; H04L 41/50; H04L 45/58

(52) U.S. Cl. CPC H04L 45/304; H04L 41/5032; H04L 45/58

(57) ABSTRACT

Techniques for a head-end node in one or more network autonomous systems to utilize a protocol to instantiate services on tail-end nodes. The head-end node can use a service request mechanism that is enabled by the protocol to request service instantiation on the tail-end node without a network operator having to manually configure the tail-end node, or even having access to the tail-end node. Additionally, the protocol may further provide mechanisms to define handling attributes for traffic of the service (e.g., Service-Level Agreement (SLA) parameters, an underlay transport protocol, etc.), service acknowledgement mechanisms for the head-end node to determine that the service was instantiated on the tail-end node, and so forth. In this way, a head-end node can be used to instantiate a service on a tail-end node without a network operator having to have direct access to the tail-end node to manually configure the tail-end node.

### CROSS REFERENCE TO RELATED APPLICATIONS

This application claims priority to U.S. Provisional Patent Application No. 63/276,155, filed Nov. 5, 2021, the entire contents of which are incorporated herein by reference.

### TECHNICAL FIELD

The present disclosure relates generally to mechanisms and techniques for head-end nodes to initiate on-demand instantiation of services on tail-end nodes to enable source-based provisioning of services.

### BACKGROUND

An autonomous system (AS) is a large network, or group of networks, that includes network devices that utilize a common routing policy. An AS has a set of Internet Protocol (IP) prefixes that are provided to the network devices in the network(s), and are generally controlled and supervised by a single entity or organization. Various protocols exist for communicating across one or more autonomous systems, such as Virtual Private Wire Service (VPWS), Ethernet Virtual Private Network (EVPN), and so forth.

For example, an EVPN enables users to connect dispersed sites using a Layer 2 (L2) virtual bridge. Generally, an EVPN consists of customer edge (CE) devices (e.g., hosts/servers, routers, switches, etc.) connected to provider edge (PE) routers. In some examples the PE routers can include a multiprotocol label switching (MPLS) edge switch that acts at the edge of an MPLS infrastructure. Further, VPWS L2 VPNs employ L2 services over MPLS to build a topology of point-to-point connections that connect end customer sites in a VPN. The service provisioned with these Layer 2 VPNs is known as VPWS. You can configure a VPWS instance on each associated edge device for each VPWS Layer 2 VPN.

An EVPN-VPWS network provides a framework for delivering VPWS with EVPN signaling mechanisms. The advantages of VPWS with EVPN mechanisms are single-active or all-active multihoming capabilities and support for Inter-autonomous system (AS) options associated with Border Gateway Protocol (BGP)-signaled VPNs.

Traditionally, in order to configure services (e.g., VPWS instances) on devices, such as edge devices (e.g., routers), network operators have to access each edge device and instantiate the services on the edge devices. However, having to manually configure each device is cumbersome and error prone. Further, network operators often do not have direct access to edge devices, such as when the edge devices reside in a different network AS, and the network operators are unable to provision a new service on those edge devices.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates a system-architecture diagram of an example network autonomous system (AS) where a network operator configures a head-end router with a service, and the head-end router uses a protocol to communicate with a tail-end router to enable the service on the tail-end router.

FIG. 2 illustrates a diagram of an example implementation model according to which a head-end router is provisioned to provide a service, and the head-end router communicates with a tail-end router to instantiate the service on the tail-end router.

FIG. 3 illustrates sequence diagrams for different service-provisioning transactions performed between a head-end router and a tail-end router.

FIG. 4 illustrates sequence diagrams for additional different service-provisioning transactions performed between a head-end router and a tail-end router.

FIG. 5 illustrates an example diagram of a service request Type-Length-Value (TLV) for a BGP message that provides information for a tail-end router to instantiate a service.

FIG. 6 illustrates an example diagram of a service segment list TLV for a BGP message signaling a segment list defining a segment routing (SR) path usable by the tail-end router to communicate with the head-end router.

FIG. 7 illustrates an example diagram of a service SR policy TLV for a BGP message signaling a defined SR policy that is instantiated on the tail-end node that indicates path usable by the tail-end router to communicate with the head-end router.

FIGS. 8A-8C each represent TLVs for a BPG message to signal a transport type for the tail-end router to use when communicating with the head-end router.

FIG. 9 illustrates a flow diagram of an example method for a head-end router to utilize a protocol to instantiate a service on a tail-end router.

FIG. 10 illustrates a flow diagram of an example method for a tail-end router to instantiate a service using information provided from a head-end router.

FIG. 11 is a computer architecture diagram showing an illustrative computer hardware architecture for implementing a computing device that can be utilized to implement aspects of the various technologies presented herein.

### DESCRIPTION OF EXAMPLE EMBODIMENTS

### Overview

This disclosure describes techniques for a head-end router to utilize messaging in a protocol to provide information to a tail-end router to instantiate a service on the tail-end router.

A first method to perform the techniques described herein may include receiving input from a network operator that causes a service to be instantiated on the head-end router. Further, the first method may include receiving a first BGP message from a tail-end router that indicates one or more capabilities of the tail-end router, and determining, based at least in part on the one or more capabilities, that the tail-end router supports a capability for interpreting a service request to instantiate the service on the tail-end router. The first method may additionally include generating a second BGP message that includes a service request indicating service parameters usable by the tail-end router to instantiate the service, and sending the second BGP message to the tail-end router. Additionally, the first method may include determining that the service has been instantiated on the tail-end router, and sending data traffic associated with the service via a path and to the tail-end router.

A second method to perform the techniques described herein may include techniques for a tail-end router to instantiate a service using service parameters provided from a head-end router. The second method may include sending, to the head-end router, a first BGP message that indicates one or more capabilities of the tail-end router where the one or more capabilities indicating that the tail-end router is capable of interpreting a service request to instantiate the service. The second method may further include receiving, from the head-end router, a second BGP message that includes a service request indicating service parameters usable by the tail-end router to instantiate the service, and instantiating the service on the tail-end router based at least in part on the service parameters. Further, the second method may include communicating data traffic associated with the service via a path and with the head-end router.

Additionally, the techniques described herein may be performed by a system and/or device having non-transitory computer-readable media storing computer-executable instructions that, when executed by one or more processors, performs the method described above.

### Example Embodiments

This disclosure describes techniques for a head-end node in one or more network autonomous systems to utilize a protocol, such as a Border Gateway Protocol (BGP), for signaling of services and instantiation of services on tail-end nodes. For instance, the head-end node can use a service request mechanism that is enabled by the protocol to request service instantiation on a tail-end node without a network operator having to manually configure the tail-end node, or even having configuration access to the tail-end node. In addition to the service request mechanism, the protocol may further provide mechanisms to define handling attributes for traffic of the service (e.g., Service-Level Agreement (SLA) parameters, an underlay transport protocol for the traffic, a lifetime for a connection for the traffic, etc.), service acknowledgement mechanisms for the head-end node to determine that the service was instantiated on the tail-end node, and so forth. In this way, a head-end node can be used to instantiate a service on a tail-end node without a network operator having to have direct access to the tail-end node to manually configure the tail-end node.

As noted above, it is cumbersome and error-prone for network operators to manually instantiate nodes, such as PE routers, with new services. Rather than network operators performing these operations, or requiring a network controller and protocol, the techniques described herein utilize a routing protocol to provide on-demand connectivity that is source provisioned.

Any routing protocol can be used to perform the techniques described herein. However, it may be advantageous to utilize BGP to source-provision new services on tail-end nodes due to its support of inter-AS environments, and its ability to extend support to EVPN services. Even further, EVPN and L3 services are also driven or enabled by the BGP protocol. A network operator may have direct access to a head-end node and is able to configure or instantiate a new service on the head-end node. The head-end node may then utilize the routing protocol to push meaningful information to the tail-end node about the instantiation of a new service. In this way, the tail-end node may be instantiated with the new service without the network operator having to manually instantiate the service or even have access to the tail-end node.

As noted above, BGP may be utilized as the routing protocol to push the instantiation information to the tail-end node. Generally, when a service is configured on a router, EVPN uses BGP auto-discovery to advertise appropriate routes to tell remote PE routers about the new available service along with reachability information. BGP route advertisements may be limited to a subset of remote PE routers when the advertisements are sent using BGP extended communities such as route-target, route policy, and so forth. When remote PE routers receive the EVPN routes (e.g., tail-end routers), the remote PE routers may use this information to enable the service based on local configuration. In the case of VPWS services, EVPN per-EVPN instance (EVI)-Ethernet Auto Discovery Route (EAD) is used to announce the reachability of the new service.

While the techniques below are often described with reference to MPLS and/or Segment routing (SR), the techniques are equally applicable for underlay and transport protocol such as SR version 6 (SRv6), Virtual extensible LAN (VxLAN), etc. Further, the techniques are applicable for various IP tunnels such as Generic UDP Encapsulation (GUE), MPLS-over-UDP (MPLSoUDP), Generic Routing Encapsulation (GRE), Generic Protocol Extension (GPE), Point-to-Point Protocol over Ethernet (PPPoE), and so forth. Additionally, while the techniques described herein are with reference to VPWS, the techniques around BGP are equally applicable in terms of address-family for L2 bridging services and L3VPN services.

Although the techniques described herein contemplate the use of BGP messages, other types of messages may additionally, or alternatively, be used. For example, the information communicated herein using BGP messages may additionally, or alternatively, be communicated using Locator/Identifier Separation Protocol (LISP) messages, or controller-based messages.

Certain implementations and embodiments of the disclosure will now be described more fully below with reference to the accompanying figures, in which various aspects are shown. However, the various aspects may be implemented in many different forms and should not be construed as limited to the implementations set forth herein. The disclosure encompasses variations of the embodiments, as described herein. Like numbers refer to like elements throughout.

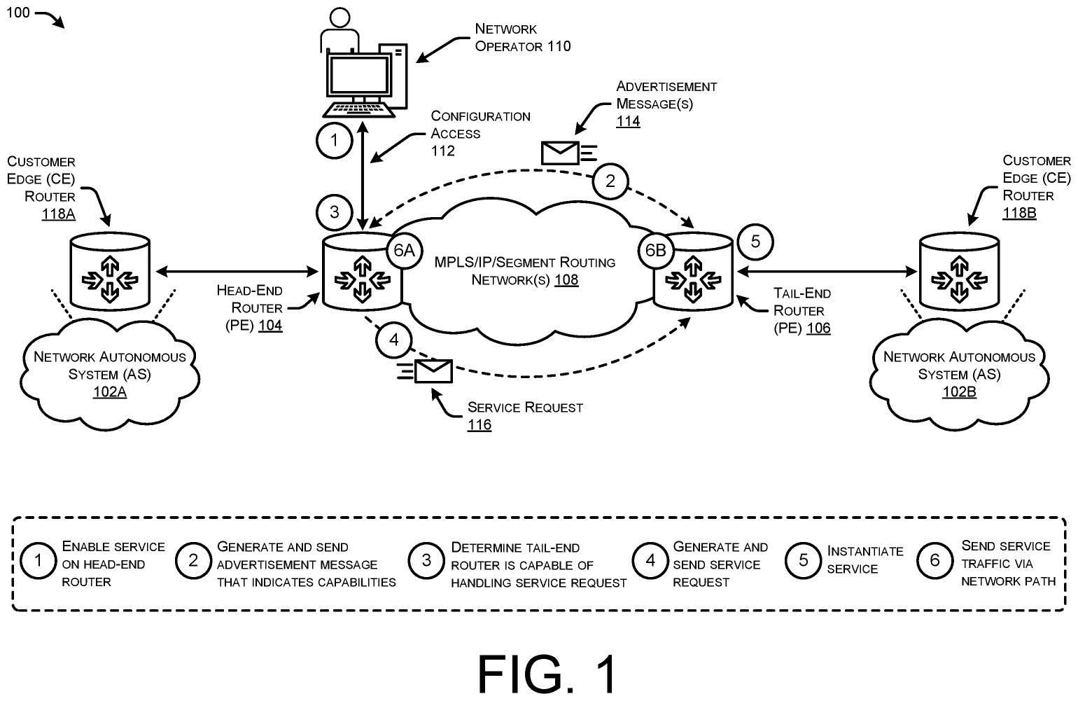

FIG. 1 illustrates a system-architecture diagram of an example network autonomous systems (AS) 102A and 102B where a network operator configures a head-end router 104 with a service, and the head-end router 104 uses a protocol to communicate with a tail-end router 106 to enable the service on the tail-end router 106.

The autonomous systems 102A and 102B (collectively referred to as “autonomous systems 102”) are each a large network, or group of networks, that includes network devices that utilize a common routing policy. The autonomous systems 102 have a set of IP prefixes that are provided to the network devices in the network(s), and are generally controlled and supervised by a single entity or organization. Various protocols exist for communicating across one or more autonomous systems, such as VPWS, EVPN, and so forth. In some examples, the autonomous systems 102 may communicate over an MPLS network 108 that switches packets using labels rather than IP addresses or layer 3 information, an IP network 108 that communicates packets using unique IP addresses, and so forth. In various examples, the autonomous systems 102 may communicate over an MPLS/IP 108 network where an IP packet is encapsulated within a packet with a header label (e.g., label switching). In some examples, the network 108 may additionally, or alternatively, be a segment routing network 108.

As illustrated, a network operator 110 may, at “1”, enable and/or provision a service on the head-end router 104. In some instances, the head-end router 104 is a PE router that is located at an edge of the autonomous system 102A and is connected to a customer edge router 118A that is located at customer premises. The service may be any type of service, such as a VPWS L2 service between two customers connected via two PE routers (104 and 106). The network operator 110 has configuration access 112 to the head-end router, but not the tail-end router 106, in some examples. In other examples, it may be time consuming and error prone for the network operator 110 to gain access and configure every PE router with a service. Thus, it is advantageous for the network operator 110 to enable the far end circuit on tail-end router 106 using his configuration access 112 to head-end router 104 and via one or more protocols. That is, the network operator 110 wants the capability to inform the tail-end router 106 about the new services provisioning, its enablement, and its application.

In some instances, the network operator 110 may provide the head-end router 104 with information about the tail-end router 106, such as an identification of the tail-end router, BGP parameters (e.g., ASN, route target, address family, etc.), the IP address of the tail-end router where a user is onboarded, the port MAC addresses where the user is onboarded, the VLAN which the user is connected or is using, the service identifier (ID) that is used to set up the new circuit, a template ID referring to a specific configuration of which the tail-end router 106 is aware, and so forth.

In various examples, the tail-end router 106 may be configured to advertise various information and/or capabilities using advertisement message(s) 114, such as BGP advertisement message(s) 114. The tail-end router 106 may, at “2,” generate and send one or more advertisement message(s) 114 to the head-end router 104 that indicate the capabilities of the tail-end router 106. The capabilities may be signaled in this way to all remote peer routers. Thus, in some instances, the head-end router 104 may also send advertisement messages 114 to remote peer routers (including the tail-end router 106) to indicate the capabilities of the head-end router 104. The capabilities may indicate whether the routers 104/106 are able to accept the service or reject at the commit time (e.g., not wait for the tail-end router 106 to ACK/NACK) to accept the service. Additionally, the head-end router 104 may determine, using the capabilities, whether the tail-end router 106 is able to understand BGP path transitional attributes which may be used to request that the tail-end router(s) 106 install, enable, instantiate, etc., the service. The attributes may be defined to be a set of elements encoded as a Type-Length-Value (TLV) based format.

At “3,” the head-end router 104 may receive the advertisement message 114 and determine that the tail-end router 106 is capable of handling a service request. For instance, the head-end router 104 may determine that the tail-end router 106 is able to instantiate the particular service that the head-end router 104 would like to instantiate on the tail-end router 106. As another example, the head-end router 104 may determine that a particular user is onboarded with the particular tail-end router 106.

At “4,” the head-end router may generate and send a service request 116 to the tail-end router 106 to instantiate the service. The service request 116 may include a service request attribute, such as an optional BGP path transitional attribute, that may be used to request that the tail-end router(s) 106 install, enable, instantiate, etc., the service. The attribute may be a BGP Service Request attribute and defined to be a set of elements encoded as a TLV-based format. The service request TLV may include various information, such as a request ID that is used for handling repeated requests, a service ID that is used to identify the service to instantiate, a MAC address indicating a port where the tail-end router(s) 106 is onboarded, VLAN tags that are used to onboard the remote PE router, and so forth. The service request TLV may then be used by the tail-end router(s) 106 to instantiate the requested service thereon.

In some examples, the service request 116, and/or another BGP message, may be used to specify other information and/or parameters for the service. For instance, the head-end router 104 may specify service level agreement (SLA) parameters to the tail-end router 106 via BGP, and instruct the tail-end router 106 to monitor the SLA(s), such as SLAs in terms of packet loss, end-to-end latency and jitter, bandwidth allocation, and notify the head-end router 104 if there is a violation of any SLA parameters.

Additionally, or alternatively, when the attributes are signaled, the head-end router 104 may send a range of values and the tail-end router 106 can select based on what is available and best parameter it can use where there may be a concept of mandatory parameters and optional parameters in the data structure and APIs. The tail-end router 106 may send acknowledgement and attributes TLV specifying its best parameters used. In some instances, there may be a need to monitor the service heart beats between the head-end and tail-end routers to indicate if the service is active. .As another example, the head-end router 104 may also give or specify a lifetime for the connection and tail-end router 106 can automatically delete the service after lifetime.

At “5,” the tail-end router 106 may receive the service request 116 and instantiate the service according to the data or parameters indicated in the service request 116. In some instances, the tail-end router 106 may perform other operations, such as authenticating the service request 116 in the signaling, associate/build local templates/profiles for the service request 116 based on incoming parameters from BGP-Service-Request TLVs, instantiate the service (e.g., instantiate EVPN-VPWS, create virtual interface in the system on the requested port (e.g., by looking at the port MAC address), add necessary encapsulation to the virtual interface as per the service attribute TLV, create EVPN neighbor for the virtual interface, install the necessary forwarding entries in hardware, and so forth.

Once instantiated, at “6,” the tail-end router 106 may send service traffic via the network path. For instance, the tail-end router 106 may steer traffic over the service path, associate with the requested transport, reply with the status success/failure message to the head-end router 104, monitor the SLAs on the instantiated service and notify if any SLA parameter (packet loss, latency, jitter) violated, and so forth. After instantiating the service on the tail-end router 106, the tail-end router 106 may additionally generate and send an acknowledgement message 116 indicating that the service was enabled.

In some examples, the tail-end router 106 may be configured to define various templates or profiles that have local meaning on the tail-end router 106 for service-instantiation purposes. In such examples, the head-end router 104 may simply signal the template ID based on the templates received from tail-end router 106 via the capability announcements. Templates may just have a local meaning on tail-end router 106 and the head-end router 104 just cares about few key parameters only to instantiate the template. Templates may also be a configuration profile where only profile ID needs to be signaled. In another example, the head-end router 104 may be configured to utilize the concept of getting a catalog from the tail-end router 106 at the head-end router 104. The head-end router 104 may use that catalog to select a specific template or profiles while performing service request.

While any routing protocol can be used to perform the techniques described herein, it may be advantageous to utilize BGP to source-provision new services on tail-end routers 106 due to its support of inter-AS environments, and its ability to extend support to EVPN services. Even further, EVPN and L3 services are also driven or enabled by the BGP protocol. After the network operator 110 uses direct configuration access 112 to configure or instantiate the new service on the head-end router 104, the head-end router 104 may then utilize the routing protocol to push meaningful information to the tail-end router 106 about the instantiation of the new service.

Thus, BGP may be utilized as the routing protocol to push the instantiation information to the tail-end node. Generally, when a service is configured on a router, EVPN uses BGP auto-discovery to advertise appropriate routes to tell remote PE routers about the new available service along with reachability information. BGP route advertisements may be limited to a subset of remote PE routers when the advertisements are sent using BGP extended communities such as route-target, route policy, and so forth. When remote PE routers receive the EVPN routes (e.g., tail-end routers 106), the remote PE routers may use this information to enable the service based on local configuration. In the case of VPWS services, EVPN per-EVPN instance (EVI)-Ethernet Auto Discovery Route (EAD) is used to announce the reachability of the new service.

Generally, the autonomous systems 102 may be any type of network that has a collection of connected IP routing prefixes under the control of one or more operators of administrative entities. The autonomous systems 102 may utilize a common and clearly defined routing policy to the Internet. An Internet Service Provider (ISP) is an example of an autonomous system 102. The autonomous systems 102 may include one or more networks implemented by any viable communication technology, such as wired and/or wireless modalities and/or technologies. The autonomous systems 102 and MPLS/IP network(s) 108 may each may include any combination of Personal Area Networks (PANs), Local Area Networks (LANs), Campus Area Networks (CANs), Metropolitan Area Networks (MANs), extranets, intranets, the Internet, short-range wireless communication networks (e.g., ZigBee, Bluetooth, etc.) Wide Area Networks (WANs)—both centralized and/or distributed—and/or any combination, permutation, and/or aggregation thereof. The networks may include devices, virtual resources, or other nodes that relay packets from one network segment to another by nodes in the computer network. Although described as head-end routers 104 and tail-end routers 106, the routers 104/106 may be and type of PE or CE router, as well as any other type of networking node on which services may be instantiated according to the techniques described herein.

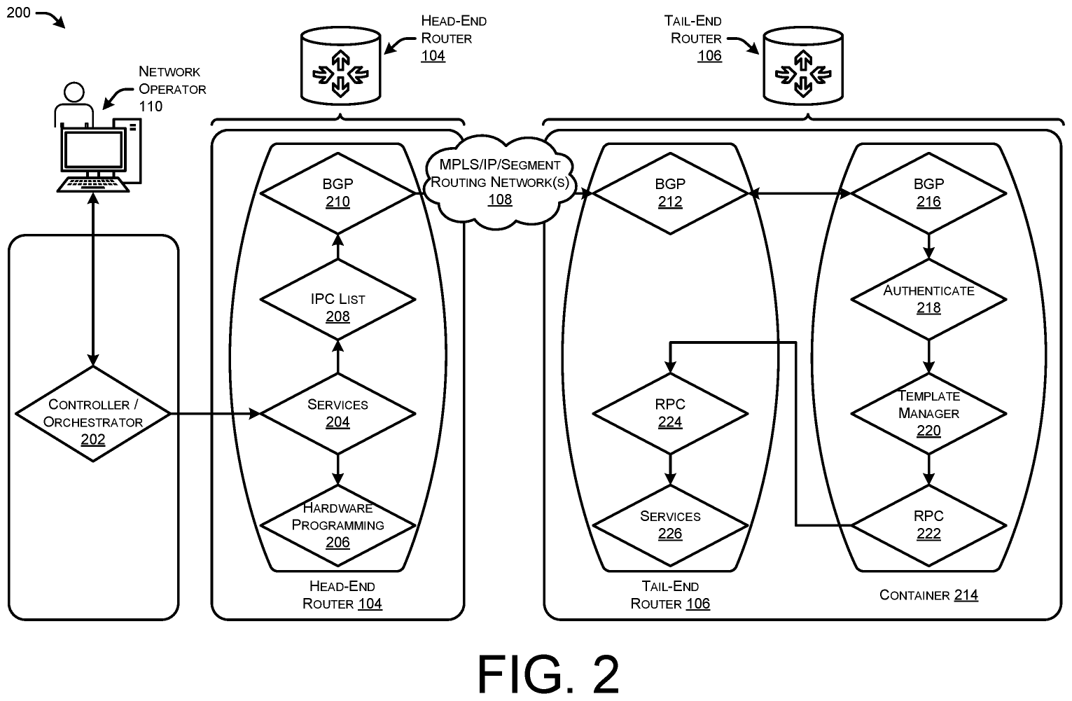

FIG. 2 illustrates a diagram 200 of an example implementation model according to which a head-end router 104 is provisioned to provide a service, and the head-end router 104 communicates with a tail-end router 106 to instantiate the service on the tail-end router 106. Insofar as numbering is similar to that of FIG. 1, the operations of FIG. 1 are also applicable in FIG. 2.

As shown, the head-end router 104 is provisioned to provide a service by a network operator 110 using a controller or orchestrator at 202. The head-end router 104 may, at 204, create the service locally which may include hardware programming 206 to implement the service and create the service locally. Additionally, the head-end router 104 may identify the intended tail-end router 106 for the service from an inter-Process Communication (IPC) list 208 of APIs, Remote Procedure Cal (RPC) APIs, and/or other APIs and communication methods.

The head-end router 104 may then, at 210, dynamically request the remote tail-end node 106 via BGP signaling to instantiate the service. The head-end router 104 may signal the parameters of the service (e.g., VLAN tags, MAC addresses, etc.) via BGP to the tail-end router 106 and signal the lifetime of the service. The head-end router 104 may activate the service locally upon successful instantiation of the service on the tail-end router 106 and steers the traffic for the service. The head-end router 104 may request the tail-end router 106 to monitor the SLAs by signaling the SLA parameters (such as latency). In case there is any SLA violation on the tail-end router 106, the head-end router 104 notifies the operator 110 about the violation.

In some instances, the head-end router 104 and tail-end router 106 may utilize a Two-Way Active Measurement Protocol (TWAMP), a Simple TWAMP (STAMP), and/or TWAMP Light parameters signaling via BGP messages. Parameters used in those protocols and between the routers 104/106 may include TWAMP profile ID/name, source/destination UDP port, TWAMP session ID, metric thresholds, return path, delay/loss measurement, packet transmit interval, measurement-mode, etc.

At 212, the tail-end router 106 may receive the service request via BGP, and in some examples, provide the BGP message(s) to a container 214 running in the tail-end router 106. The container 214 may be any type of container (e.g., Docket, Kubemetes, etc.) and operate as a generic mechanism capable of processing head-end router 104 request, validating the requests, and applying generated configuration on the tail-end router 106. The generic container 214 may provide flexibility and allow installation for receiver of a various set of devices/routers.

The Service Request mechanism used to carry service request information may be opaque to the tail-end router 106. Thus, at 212 the BGP updates from head-end router 104 are received by XR BGP where the updates may be BGP Network Layer Reachability Information (NLRIs) used in service advertisement. The NLRI may carry BGP-Service-Request attribute, and upon BGP-Service-Request attribute discovery, the NLRI along with attributes are processed by XR for BGP (in preparation of Service ACK/NACK, and are handled over to the service manager running in the container 214. The service manager running in the container 214 may include 2 parts, specifically, a BGP agent and a Sanitizer/Verifier validating the information carried within the BGP-Service-Request attribute.

The service manager on the container 214 may operate in two modes: PUSH or PULL mode. The objective is to carry over the relevant information from the tail-end router 106 for further processing within the container 214 environment.

In the PUSH mode, an iBGP “route reflector client” session is established between a BGP daemon running in the container 214. In the PULL mode, a pull model with a periodic polling is used to receive BGP path updates. Both models leverage a BGP daemon, and the customized BGP implementation will dissect the update received and unpack the attributes for the service building.

At 218, the container 214 than authenticates, or “sanitizes,” the requests. Each single request may go through many rules before being accepted as a valid request. Incoming extracted values are compared with pre-configure local parameters. There are additional checks which may be performed. For instance, to prevent oscillations, verification may be performed to avoid any oscillation in terms of configuring and withdrawing excessively. Also, a peer may not exceed the number of defined services requests. Standard BGP filtering (max prefix) and route dampening may be used as an extra layer for sanitizing and validating services.

At 220, as each service request is dissected, a template manager converts this in the right yang configuration models for the service. A config daemon may then launch standard Netconf requests over to the tail-end router 106 (e.g., virtual machine) with the newly created templates using, for example, a remote procedure call at 222/224.

Once the configuration is successfully applied on the tail-end router 106, the EVPN routes are constructed, and proper Service ACK/NACK is attached to that NLRI prior to BGP advertisement. The Service Provision Mechanism uses an acknowledgement mechanism where the tail-end router 106 reports back to the head-end router 104 the status of the transaction. In addition to sanitizer/verifier of the service request, the container 214 may check with a security/authentication process to validate the service request.

In some instances, gRPC APIs provided by the tail-end router 106 to the container 214 process are used where the container 214 converts the BGP attributes received from the head-end router 104 to API calls for create, update and delete service requests on the tail-end router 106. There is a corresponding local IOS-XR process running that handles the gRPC messages. There are also APIs from the IOS-XR process to the container 214 to notify the status of the services. The BGP on the container 214 uses that notification to signal to the head-end router 104.

In another example, the techniques include using the direct AIPC APIs between processes running in the VM of the tail-end router 106 without using the container 214. In this case, the AIPCs APIs allow to create, update and delete requests directly on the router without creating configuration in the VM.

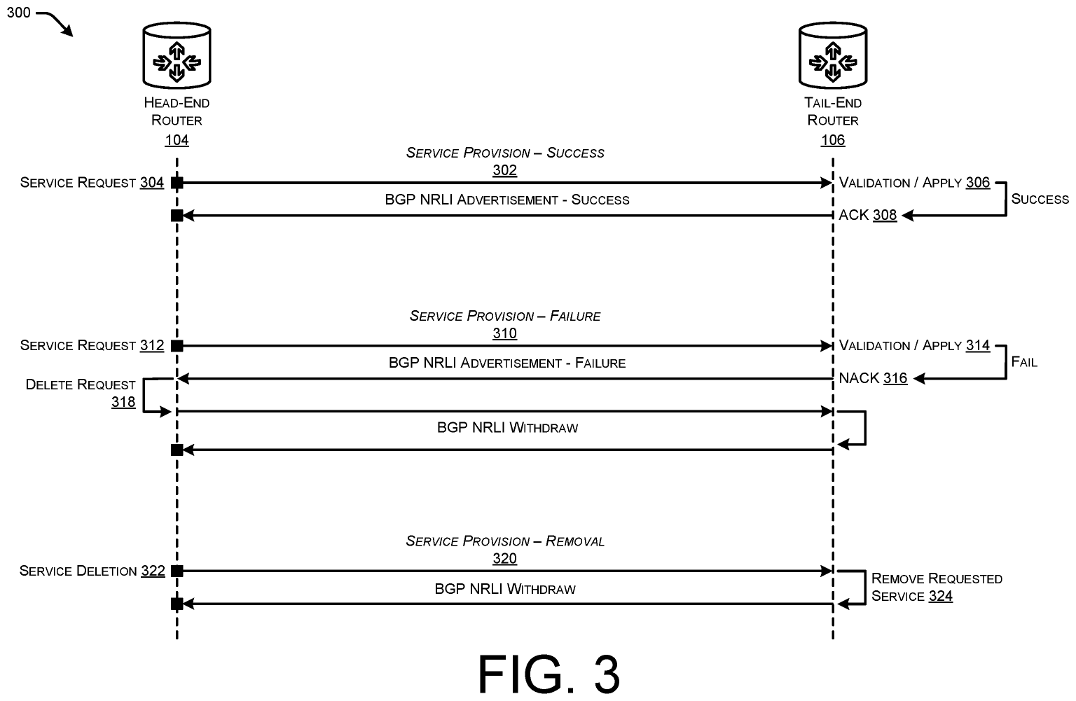

FIG. 3 illustrates sequence diagrams for different service-provisioning transactions performed between a head-end router 104 and a tail-end router 106.

A service provision—success diagram 302 is illustrated where a head-end router 104 sends a service request at 304 to the tail-end router 106. The tail-end router 106 may validate and apply the requested service at 306. If the service is successfully provisioned, the tail-end router 106 sends an acknowledgement (ACK) at 308 to the head-end router 104. In some instances, the communications may be performed at least partly using BGP NRLI advertisement(s).

A service provision—fail diagram 310 is illustrated where a head-end router 104 sends a service request at 312 to the tail-end router 106 using an BGP NRLI advertisement. The tail-end router 106 may attempt to validate and apply the requested service at 314. If the tail-end router 106 fails in provisioning the service, the tail-end router 106 sends a NACK at 308 to the head-end router 104. After receiving the NACK, the head-end router 104 may, at 318, delete the request for the service and send an indication to the tail-end router 106 to delete the request using BGP NRLI withdraw. The tail-end router 106 may delete the request to instantiate the service and notify the head-end router 104 that the request was successfully deleted.

A service provision—removal diagram 320 is illustrated where a head-end router 104 sends a service deletion request at 322 to the tail-end router 106 using BGP NRLI withdraw once the service is to be deleted. The tail-end router 106 may receive the service deletion 322 request, and tear down, delete, or otherwise remove the service from the tail-end router at 324. The tail-end router 106 may notify the head-end router 104 of the successful removal of the service.

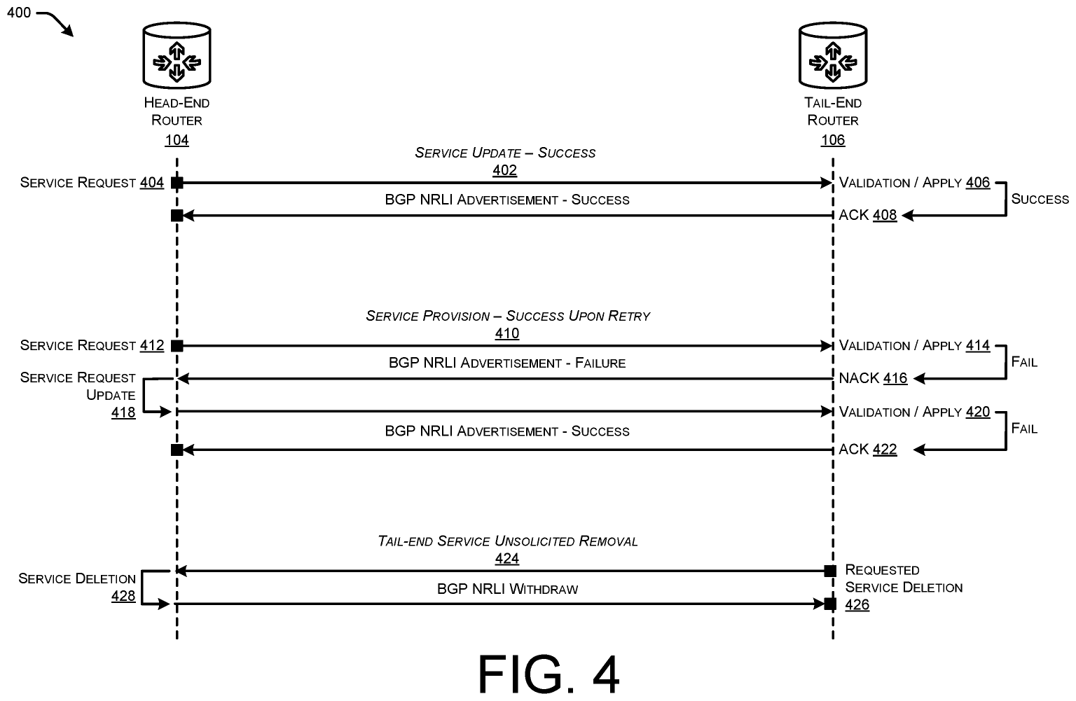

FIG. 4 illustrates sequence diagrams for additional different service-provisioning transactions performed between a head-end router 104 and a tail-end router 106.

A service provision—success diagram 402 is illustrated where a head-end router 104 sends a service request at 404 to the tail-end router 106. The tail-end router 106 may validate and apply the requested service at 406. If the service is successfully provisioned, the tail-end router 106 sends an acknowledgement (ACK) at 408 to the head-end router 104. In some instances, the communications may be performed at least partly using BGP NRLI advertisement(s).

A service provision—success upon retry diagram 410 is illustrated where a head-end router 104 sends a service request at 412 to the tail-end router 106. The tail-end router 106 may attempt to validate and apply the requested service at 414. If the tail-end router 106 fails in provisioning the service, the tail-end router 106 sends a NACK at 416 to the head-end router 104. After receiving the NACK, the head-end router 104 may, at 418, perform a service request update where the service request is updated to avoid the failure on the tail-end router 106. That is, the initial service request may have been missing needed information for the service to be applied, be in an incorrect format, or otherwise be unusable by the tail-end router 106 to provision the service. The updated service request may be sent, at 418, to the tail-end router 106. At 420, the tail-end router 106 may validate/apply the updated service request. If the service is successfully provisioned, the tail-end router 106 sends an ACK at 422 to the head-end router 104. In some instances, the communications may be performed at least partly using BGP NRLI advertisement(s).

A tail-end service unsolicited removal diagram 424 is illustrated where the tail-end router 106 requests a service deletion at 426, and the head-end router 104 deletes the service at 418.

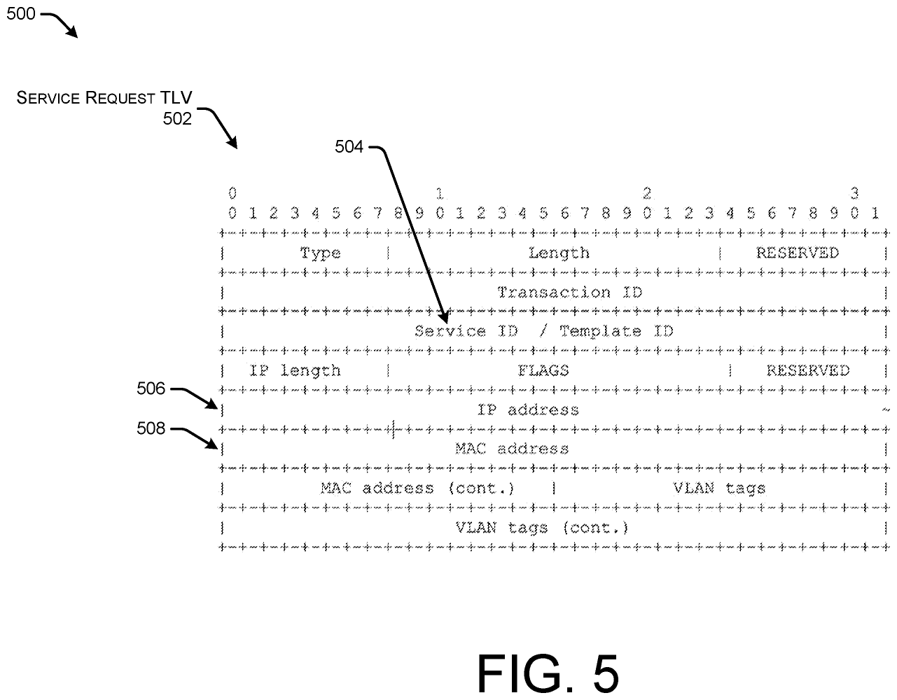

FIGS. 5-7 show example formats of TLVs that may be used to implement portions of this disclosure. However, the formats of the TLVs are simply example formats, and the formats may be changed/modified based on the environment or other factors.

FIG. 5 illustrates an example diagram 500 of a service request Type-Length-Value (TLV) for a BGP message that provides information for a tail-end router 106 to instantiate a service.

Generally, the tail-end router 106 may rely on protocols that are running to help identify a specific user. Rather than configuring many static parameters, the network operator 110 may provide, as an example, only the IP address of the onboarded user. The head-end router 104 performs the service request using that IP address where the IP address is carried as part of the BGP-Service-Request TLV 502. Optionally, a list of or a specific tail-end router IP address may also be provided. The tail-end router 106, upon reception of a service request TLV 502, extracts the onboarded user IP address 506. Using local ARP/ND tables, the tail-end router 106 can identify the connected port and the associated VLAN-ID. Upon VM motion, a new ARP/ND entry is learned/created, which may trigger dynamic re-adjustment in the circuit hardware programming. Since multiple nodes may have received initial head-end request, it is possible for them to “wake-up” upon motion and take over, in a dynamic fashion, the requested service. The new tail-end router 106 sends back newly ACK to the head-end router 104 with update reachability information. Hitless VM motion may be done by performing well-known make-before break setup.

The service request TLV 502 may also carry the user IP address 506. A new flag is also defined indicating the meaning of each field. For instance, the IP address 506 may indicate either the tail-end router 106 or the user IP address. Similar logic applies where the MAC address 508 may indicate either the port or the customer MAC address.

As an example, the flags may be defined as:
Bit 0−>0: tail-end router, and 1: customer IP address
Bit 1−>0: port MAC address, and 1: customer MAC address

The concept work with bridging when MAC mobility may also be supported. In term of VPWS/P2P connectivity, it also allows for P2P mobility. In this case, the usage of EVPN mobility attribute must be attached to EVPN-VPWS route to inform the head-end of possible circuit motion. Head-end router 104 receives updated reachability information. By looking at the EVPN mobility extended community, it validates them based what it the latest (more up-to-date) BGP route received.

Similarly, other protocols such as DHCP may also be leveraged. For instance, DHCP snooping table can be consulted to understand to where specific users are connected. By using the DHCP snooping binding table, onboarded users may also be identified by their own MAC addresses (instead of being identified by an IP address). Again, the purpose is to identify the port where a user is connected at the tail-end router 106. In the latter case, the head-end router 104 performs service request where customer MAC address is carried over the BGP-Service-Request TLV 502.

The techniques are applicable with multi-homed tail-end routers 106. With EVPN multi-homing running on them. DHCP, ARP/ND synchronization happens between them.

Generally, the service request TLV 502 may have a type of “1,” a length of “X” that is the total length in bytes of the value portion of the TLV. The service request TLV 502 may include a request ID that may be a 4-byte value provided by the head-end router 104. The request ID may serve multiple purposes, such as handling repeated request. The service request TLV 502 may further include a service ID 504 that may be a 4 byte value identifying the service to instantiate. In the case of VPWS, the service ID 504 may be the equivalent of Ethernet tag ID. The usage of service ID 504 may refer to a specific template ID describing the service to instantiate and that is known by tail-end router 106. The service request TLV 502 may further include the MAC address 312 of the port where a user of the device is onboarded, as well as one or more VLAN tags, which may be an Ethernet TAG value to enable to the onboard router 106, which may be a singled-tag or double-tag VID.

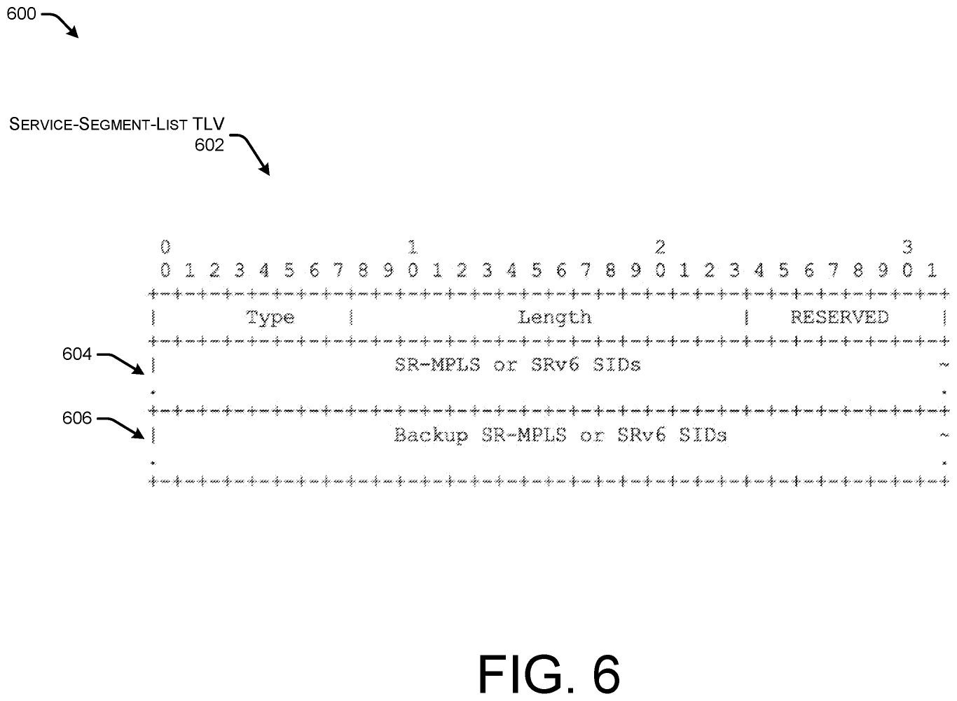

FIG. 6 illustrates an example diagram 600 of a service segment list TLV 602 for a BGP message signaling a segment list defining a segment routing (SR) path usable by the tail-end router to communicate with the head-end router 104.

Generally, services may require a bidirectional SR Policy as a transport on a co-routed path in the forward and reverse directions. The SR Policy can take advantage of traffic engineering, fast reroute, path protection and PM/OAM, shortest IGP/delay paths, co-routed path in both directions and steering of service traffic over the policy. SR Policy may be protected, and path diverse SR Policies may be provided.

The forward and reverse SR Paths may be provisioned on the head-end router 104 using an orchestrator or a controller. The segment-list of the path from the tail-end needs to be communicated to the tail-end node for the traffic to flow on a co-routed bidirectional path. Using the received segment-list, which may be expressed as SR-MPLS or SRvSegment Identifiers (STDs), automatically SR policy is instantiated on the tail-end node to transport the service. The Service-Segment-list TLV is defined in FIG. 6 that has a SR-MPLS or SRv6 SIDS field 604 and a backup SR-MPLS or SRv6 SIDS field 606.

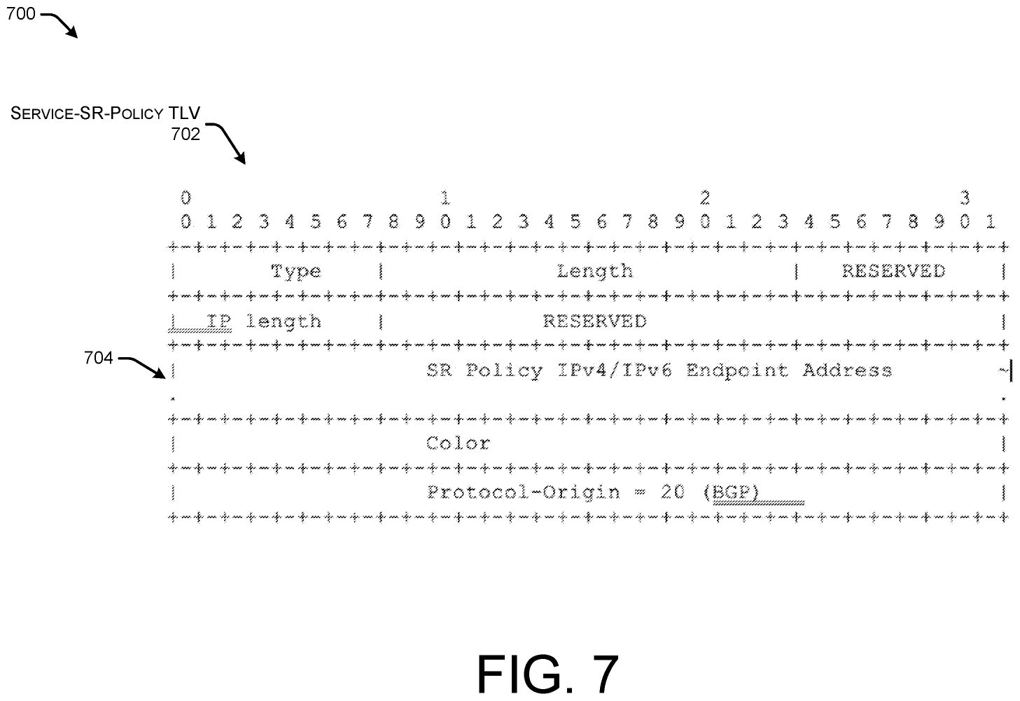

FIG. 7 illustrates an example diagram 700 of a service SR policy TLV 702 for a BGP message signaling a defined SR policy 704 that is instantiated on the tail-end router 106 that indicates path usable by the tail-end router 106 to communicate with the head-end router 104.

Services require bidirectional SR Policy on a co-routed path in the forward and reverse directions. If the SR Policy 704 is already instantiated on the tail-end router 106 by the service provider, the head-end router 104 may be provisioned to use the provisioned SR Policy 704. In this case, the SR Policy 704 tuple is signaled via the BGP to identify the associated SR Policy 704 for the service on the tail-end router 106. The Service-SR-Policy TLV may defined as shown in FIG. 7.

The operator may provision only the IGP Flex Algo SID instead of SR Policy as transport on the head-end router 104. In that case, the head-end router 104 signals the IGP Flex Algo SID to the tail-end router 106.

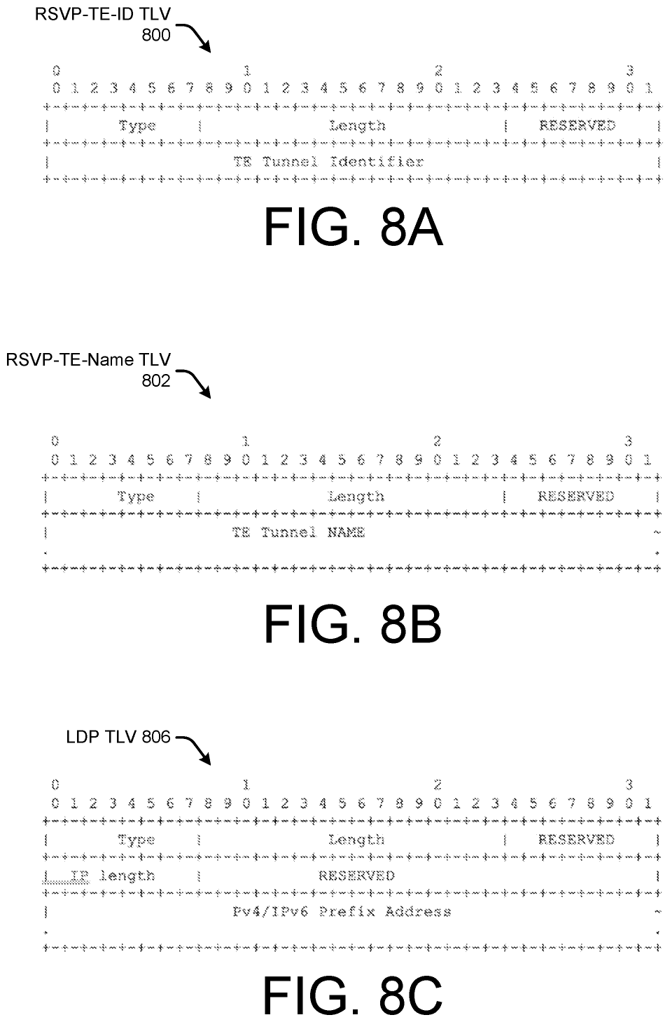

FIGS. 8A-8C each represent TLVs for a BPG message to signal a transport type for the tail-end router to use when communicating with the head-end router.

The head-end router 104 may signal to use Resource Reservation Protocol—Traffic Engineering (RSVP-TE) or Label Distribution Protocol (LDP) path as transport as well instead of SR path to carry the service on the tail-end. The encapsulation BGP extended community many be attached to BGP routes to indicate the type of underlay being used. It allows the differentiation between MPLS, SRV6, VxLAN, etc.

Although not illustrated, additional TLVs may be included in BGP messages, such as a service measurement TLV. The service measurement TLV may include a request for information usable for operations, administration, and management (OAM). For instance, the service measurement TLV may include a request for timestamp data that is usable to measure the round-trip delay between the service request and a service acknowledgement sent from the remote PE routers. As additional examples, the parameters in the BGP messages could include indications for Label Switched Path (LSP) Ping, Traceroute, Bidirectional Forwarding Detection (BFD)/S-BFD protocol (e.g., for connectivity verification), packet transmit interval, packet missed counts, and/or other OAM information.

FIG, 8A illustrates an example RSVP-TE-ID TIN 800 used to indicate a traffic engineering tunnel identifier to use for the transport for the service path. FIG. 8B illustrates a RSVP-TE-Name TLV 802 that is used to indicate a traffic engineering tunnel name to use for the transport for the service path. Further, FIG. 8C indicates an LDP TLV 806 that is used to indicate or specify an IPv4/IPV6 prefix address to indicate the LDP path used for the transport for the service path.

The underlay can also be a GRE (Generic Route Encapsulation) tunnels or IP-SEC tunnel. It is also signaled using a BGP service request TLV. There may also need to signal the authentication parameters for the circuit to be created. It is signaled using a BGP service request TLV.

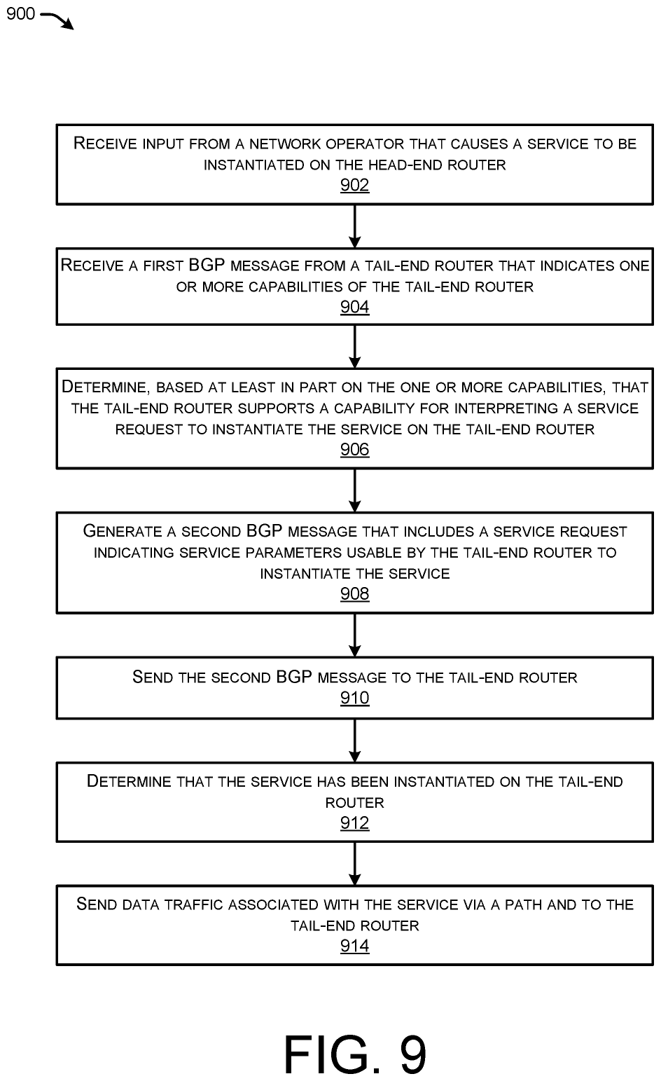

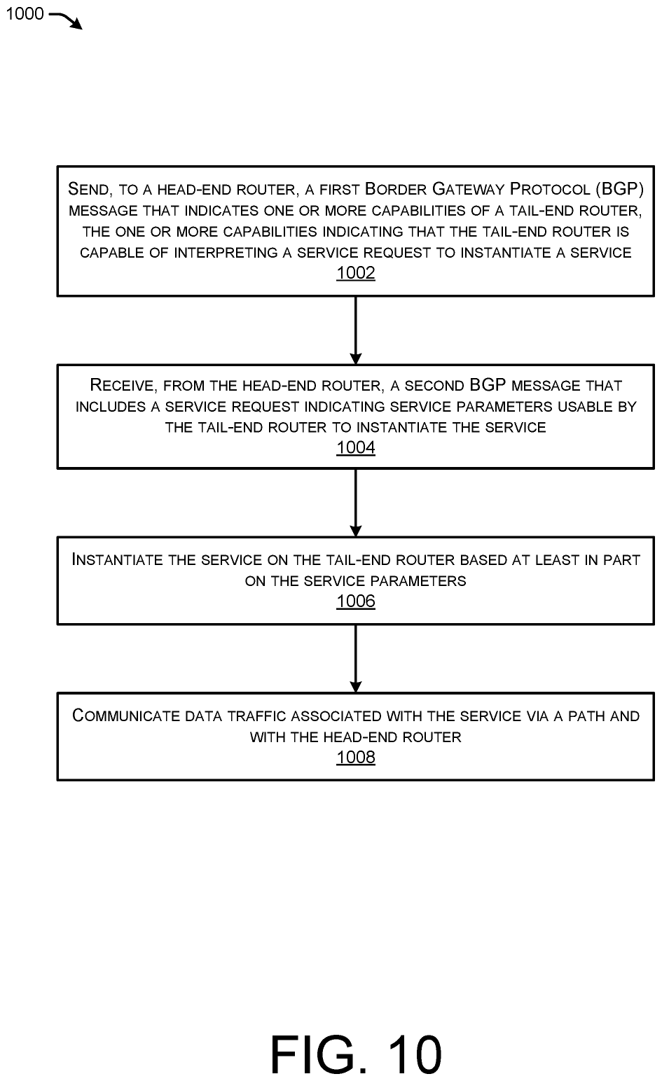

FIGS. 9 and 10 illustrate flow diagrams of example methods 900 and 1000 that illustrate aspects of the functions performed at least partly by the devices in the distributed application architecture as described in FIGS. 1-8. The logical operations described herein with respect to FIGS. 9 and 10 may be implemented (1) as a sequence of computer-implemented acts or program modules running on a computing system and/or (2) as interconnected machine logic circuits or circuit modules within the computing system.

The implementation of the various components described herein is a matter of choice dependent on the performance and other requirements of the computing system. Accordingly, the logical operations described herein are referred to variously as operations, structural devices, acts, or modules. These operations, structural devices, acts, and modules can be implemented in software, in firmware, in special purpose digital logic, and any combination thereof. It should also be appreciated that more or fewer operations might be performed than shown in the FIGS. 9 and 10 and described herein. These operations can also be performed in parallel, or in a different order than those described herein. Some or all of these operations can also be performed by components other than those specifically identified. Although the techniques described in this disclosure is with reference to specific components, in other examples, the techniques may be implemented by less components, more components, different components, or any configuration of components.

FIG. 9 illustrates a flow diagram of an example method 900 for a head-end router 104 to utilize a protocol to instantiate a service on a tail-end router 106. The method may be for a first router (e.g., head-end router 104) to utilize a protocol (e.g., BGP or another routing protocol) to provide instantiation information to a second router (e.g., tail-end router 106) that is usable to instantiate a service on the second router.

At 902, the head-end router 104 may receive input from a network operator that causes the service to be instantiated on the head-end router 104. For instance, the network operator 110 may provide configuration information to the head-end router 104 that causes the first router to be enabled with a service.

At 904, the head-end router 104 may receive a first BGP message from a tail-end router 106 that indicates one or more capabilities of the tail-end router 106. The capabilities may indicate whether or not the tail-end router 106 is able to instantiate the service.

At 906, the head-end router 104 may determine, based at least in part on the one or more capabilities, that the tail-end router 106 supports a capability for interpreting a service request to instantiate the service on the tail-end router 106.

At 908, the head-end router 104 may generate a second BGP message that includes a service request indicating service parameters usable by the tail-end router 106 to instantiate the service. In some instances, the second BGP message includes a service request attribute that is a set of elements encoded as a Type-Length-Values (TLV), and the service request attribute is a service-request TLV that includes an indication of at least one of an Internet Protocol (IP) address or a Media Access Control (MAC) address of a user device associated with a particular user of the service. In such examples, the at least one of the IP address or the MAC address is usable by the second router to identify at least one of a Virtual Local Area Network (VLAN) identifier (ID) to which the user device is connected, or a port MAC address to which the user device is connected.

In some instances, the service parameters are a template identifier (ID) that refers to a template defining specific configuration usable by the second router to instantiate the service.

At 910, the head-end router 104 may send the second BGP message to the tail-end router 106, and at 912, the head-end router 104 may determine that the service has been instantiated on the tail-end router 106. For instance, the head-end router 104 may receive an ACK message from the tail-end router 106 indicating that the service was instantiated on the tail-end router 106.

At 912, the head-end router 104 may send data traffic associated with the service via a path and to the tail-end router 106.

In some examples, the head-end router may receive an acknowledgement packet from the tail-end router indicating that the service has been instantiated on the tail-end router. Generally, BGP capabilities are per node/router, whereas ACK/NACK packets are per-circuit as requested by the head-end router 104. Thus, there may be multiple requests for different circuits from the same tail-end router 106. Accordingly, ACK packets/messages may be used to carry the service label as well as the remote IP address. This is the service ID which may be missing from the BGP capability advertisement.

FIG. 10 illustrates a flow diagram of an example method 1000 for a tail-end router 106 to instantiate a service using information provided from a head-end router 104.

At 1002, the tail-end router 106 may send, to the head-end router 104, a first Border Gateway Protocol (BGP) message that indicates one or more capabilities of the tail-end router 106 where the one or more capabilities indicating that the tail-end router is capable of interpreting a service request to instantiate the service.

At 1004, the tail-end router 106 may receive, from the head-end router 104, a second BGP message that includes a service request indicating service parameters usable by the tail-end router to instantiate the service.

At 1006, the tail-end router 106 may instantiate the service on the tail-end router based at least in part on the service parameters, and at 1008, the tail-end router 106 may communicate data traffic associated with the service via a path and with the head-end router 104.

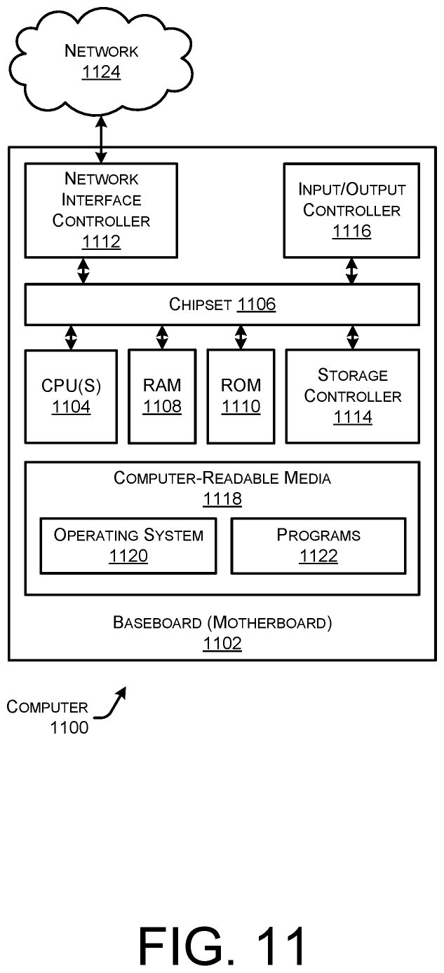

FIG. 11 shows an example computer architecture for a computer 1100 capable of executing program components for implementing the functionality described above. The computer architecture shown in FIG. 11 illustrates a conventional router, switch, node, or other computing device, and can be utilized to execute any of the software components presented herein. The computer 1100 may, in some examples, correspond to a head-end router 104, a tail-end router 106, and/or another device described herein, and may comprise networked devices such as servers, switches, routers, hubs, bridges, gateways, modems, repeaters, access points, etc.

The computer 1100 includes a baseboard 1112, or “motherboard,” which is a printed circuit board to which a multitude of components or devices can be connected by way of a system bus or other electrical communication paths. In one illustrative configuration, one or more central processing units (“CPUs”) 1104 operate in conjunction with a chipset 1106. The CPUs 1104 can be standard programmable processors that perform arithmetic and logical operations necessary for the operation of the computer 1100.

The CPUs 1104 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 1106 provides an interface between the CPUs 1104 and the remainder of the components and devices on the baseboard 1112. The chipset 1106 can provide an interface to a RAM 1108, used as the main memory in the computer 1100. The chipset 1106 can further provide an interface to a computer-readable storage medium such as a read-only memory (“ROM”) 1110 or non-volatile RAM (“NVRAM”) for storing basic routines that help to startup the computer 1100 and to transfer information between the various components and devices. The ROM 1110 or NVRAM can also store other software components necessary for the operation of the computer 1100 in accordance with the configurations described herein.

The computer 1100 can operate in a networked environment using logical connections to remote computing devices and computer systems through a network, such as the network 1124. The chipset 1106 can include functionality for providing network connectivity through a NIC 1112, such as a gigabit Ethernet adapter. The NIC 1112 is capable of connecting the computer 1100 to other computing devices over the network 1124. It should be appreciated that multiple NICs 1112 can be present in the computer 1100, connecting the computer to other types of networks and remote computer systems.

The computer 1100 can be connected to a storage device 1118 that provides non-volatile storage for the computer. The storage device 1118 can store an operating system 1120, programs 1122, and data, which have been described in greater detail herein. The storage device 1118 can be connected to the computer 1100 through a storage controller 1114 connected to the chipset 1106. The storage device 1118 can consist of one or more physical storage units. The storage controller 1114 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computer 1100 can store data on the storage device 1118 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 1118 is characterized as primary or secondary storage, and the like.

For example, the computer 1100 can store information to the storage device 1118 by issuing instructions through the storage controller 1114 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 1100 can further read information from the storage device 1118 by detecting the physical states or characteristics of one or more particular locations within the physical storage units.

In addition to the mass storage device 1118 described above, the computer 1100 can have access to other computer-readable storage media to store and retrieve information, such as program modules, data structures, or other data. It should be appreciated by those skilled in the art that computer-readable storage media is any available media that provides for the non-transitory storage of data and that can be accessed by the computer 1100. In some examples, the operations performed by devices such as the head-end router 104, tail-end router 106, and so forth, and or any components included therein, may be supported by one or more devices similar to computer 1100. Stated otherwise, some or all of the operations performed by the head-end router 104, tail-end router 106, and or any components included therein, may be performed by one or more computer devices 1100.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 1118 can store an operating system 1120 utilized to control the operation of the computer 1100. According to one embodiment, the operating system comprises the LINUX operating system. According to another embodiment, the operating system comprises the WINDOWS® SERVER operating system from MICROSOFT Corporation of Redmond, Wash. According to further embodiments, the operating system can comprise the UNIX operating system or one of its variants. It should be appreciated that other operating systems can also be utilized. The storage device 1118 can store other system or application programs and data utilized by the computer 1100.

In one embodiment, the storage device 1118 or other computer-readable storage media is encoded with computer-executable instructions which, when loaded into the computer 1100, transform the computer from a general-purpose computing system into a special-purpose computer capable of implementing the embodiments described herein. These computer-executable instructions transform the computer 1100 by specifying how the CPUs 1104 transition between states, as described above. According to one embodiment, the computer 1100 has access to computer-readable storage media storing computer-executable instructions which, when executed by the computer 1100, perform the various processes described above with regard to FIGS. 1-10. The computer 1100 can also include computer-readable storage media having instructions stored thereupon for performing any of the other computer-implemented operations described herein.

The computer 1100 can also include one or more input/output controllers 1116 for receiving and processing input from a number of input devices, such as a keyboard, a mouse, a touchpad, a touch screen, an electronic stylus, or other type of input device. Similarly, an input/output controller 1116 can provide output to a display, such as a computer monitor, a flat-panel display, a digital projector, a printer, or other type of output device.

As described herein, the computer 1100 may comprise one or more of a head-end router 104, tail-end router 106, and/or other device. The computer 1100 may include one or more hardware processors 1104 (processors) configured to execute one or more stored instructions. The processor(s) 1104 may comprise one or more cores. Further, the computer 1100 may include one or more network interfaces configured to provide communications between the computer 1100 and other devices, such as the communications described herein as being performed by the head-end router 104 and/or tail-end router 106. The network interfaces may include devices configured to couple to personal area networks (PANs), wired and wireless local area networks (LANs), wired and wireless wide area networks (WANs), and so forth. For example, the network interfaces may include devices compatible with Ethernet, Wi-Fi™, and so forth.

The programs 1122 may comprise any type of programs or processes to perform the techniques described in this disclosure by the head-end router 104 and/or tail-end router 106.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A method for a first router to utilize a Border Gateway Protocol (BGP) to dynamically request that a second router instantiate a service on the second router, the method comprising:
receiving, at the first router, input from a network operator that causes the service to be instantiated on the first router;
receiving, at the first router, a first BGP message from the second router that indicates one or more capabilities of the second router;
determining, based at least in part on the one or more capabilities, that the second router supports a capability for interpreting a service request to instantiate the service on the second router;
generating, at the first router, a second BGP message that includes a service request indicating service parameters usable by the second router to instantiate the service;
sending, from the first router, the second BGP message to the second router;
receiving, at the first router and from the second router, an acknowledgement packet indicating that the service has been instantiated on the second router; and
sending, from the first router, data traffic associated with the service via a path and to the second router.

2. The method of claim 1, further comprising:
receiving, at the first router, a service level agreement (SLA) parameter associated with the data traffic;
sending the SLA parameter to the second router via at least one of the second BGP message or a third BGP message;
receiving, at the first router, an indication that the SLA parameter associated with the data traffic was violated; and
providing the network operator with an alert that the SLA parameter was violated.

3. The method of claim 1, wherein:
the second BGP message includes a service request attribute that is a set of elements encoded as a Type-Length-Values (TLV);
the service request attribute is a service-request TLV that includes an indication of at least one of:
an Internet Protocol (IP) address of a user device associated with a particular user of the service;
a Media Access Control (MAC) address of the user device;
a Virtual Local Area Network (VLAN) identifier (ID) to which the user device is connected;
a destination router identifier;
a destination port identifier;
a destination port MAC address; or
a port MAC address to which the user device is connected.

4. The method of claim 1, wherein determining that the service has been instantiated on the second router includes receiving, from the second router, an acknowledgement message indicating that the service was instantiated on the second router.

5. The method of claim 1, wherein the service parameters are at least one of:
a template identifier (ID) that refers to a template defining specific configuration usable by the second router to instantiate the service;
a hash-key that indicates the template;
an encrypted hash-key that indicates the template; or
a catalog key that indicates the template.

6. The method of claim 1, further comprising sending, from the first router, at least one of:
an indication of a lifetime for a connection established between the first router and the second router via at least one of the second BGP message or a third BGP message; or an indication of at least one of a latency, jitter, or bandwidth allocation for the connection established between the first router and the second router via at least one of the second BGP message or the third BGP message.

7. The method of claim 1, wherein the service request included in the second BGP message sent to the second router includes an indication of an underlay transport protocol for the second router to use to communicate the data traffic with the first router.

8. A head-end router comprising:
one or more processors; and
one or more non-transitory computer-readable media storing computer-executable instructions that, when executed by the one or more processors, cause the one or more processors to perform operations comprising:
receiving input from a network operator that causes a service to be instantiated on the head-end router;
receiving a first Border Gateway Protocol (BGP) message from a tail-end router that indicates one or more capabilities of the tail-end router;
determining, based at least in part on the one or more capabilities, that the tail-end router supports a capability for interpreting a service request to instantiate the service on the tail-end router;
generating a second BGP message that includes a service request indicating service parameters usable by the tail-end router to instantiate the service;
sending the second BGP message to the tail-end router;
receiving, at the head-end router and from the tail-end router, an acknowledgement packet indicating that the service has been instantiated on the tail-end router; and
sending data traffic associated with the service via a path and to the tail-end router.

9. The head-end router of claim 8, the operations further comprising:
receiving a service level agreement (SLA) parameter associated with the data traffic;
sending the SLA parameter to the tail-end router via at least one of the second BGP message or a third BGP message;
receiving an indication that the SLA parameter associated with the data traffic was violated; and
providing the network operator with an alert that the SLA parameter was violated.

10. The head-end router of claim 8, wherein:
the second BGP message includes a service request attribute that is a set of elements encoded as a Type-Length-Values (TLV);
the service request attribute is a service-request TLV that includes an indication of at least one of:
an Internet Protocol (IP) address of a user device associated with a particular user of the service;
a Media Access Control (MAC) address of the user device;
a Virtual Local Area Network (VLAN) identifier (ID) to which the user device is connected;
a destination router identifier;
a destination port identifier;
a destination port MAC address; or
a port MAC address to which the user device is connected.

11. The head-end router of claim 8, wherein determining that the service has been instantiated on the tail-end router includes receiving, from the tail-end router, an acknowledgement message indicating that the service was instantiated on the tail-end router.

12. The head-end router of claim 8, wherein the service parameters are at least one of:
a template identifier (ID) that refers to a template defining specific configuration usable by the second router to instantiate the service;
a hash-key that indicates the template;
an encrypted hash-key that indicates the template; or
a catalog key that indicates the template.

13. The head-end router of claim 8, the operations further comprising sending an indication of a lifetime for a connection established between the head-end router and the tail-end router via at least one of the second BGP message or a third BGP message.

14. The head-end router of claim 8, wherein the service request included in the second BGP message sent to the tail-end router includes an indication of an underlay transport protocol for the tail-end router to use to communicate the data traffic with the head-end router.

15. A method for a tail-end router to instantiate a service using service parameters provided from a head-end router, the method comprising:
sending, to the head-end router, a first Border Gateway Protocol (BGP) message that indicates one or more capabilities of the tail-end router, the one or more capabilities indicating that the tail-end router is capable of interpreting a service request to instantiate the service;
receiving, from the head-end router, a second BGP message that includes a service request indicating service parameters usable by the tail-end router to instantiate the service;
instantiating the service on the tail-end router based at least in part on the service parameters;
sending, to the head-end router, an acknowledgement message indicating that the service has been instantiated on the tail-end router; and
communicating data traffic associated with the service via a path and with the head-end router.

16. The method of claim 15, further comprising:
receiving, from the head-end router, a service level agreement (SLA) parameter associated with the data traffic;
determining that communication of the data traffic violated the SLA parameter; and
sending, to the head-end router, an indication that the SLA parameter associated with the data traffic was violated.

17. The method of claim 15, wherein:
the second BGP message includes a service request attribute that is a set of elements encoded as a Type-Length-Values (TLV);
the service request attribute is a service-request TLV that includes an indication of at least one of an Internet Protocol (IP) address or a Media Access Control (MAC) address of a user device associated with a particular user of the service;
the at least one of the IP address or the MAC address is usable by the second router to identify at least one of:
a Virtual Local Area Network (VLAN) identifier (ID) to which the user device is connected; or
a port MAC address to which the user device is connected.

18. The method of claim 15, further comprising:
in response to the service being instantiated on the tail-end router, sending an acknowledgment message to the head-end router indicating that the service was instantiated on the tail-end router.

19. The method of claim 15, further comprising receiving, from the head-end router, an indication of a lifetime for a connection established between the head-end router and the tail-end router via at least one of the second BGP message or a third BGP message.

20. The method of claim 15, wherein the service request included in the second BGP message includes an indication of an underlay transport protocol for the tail-end router to use to communicate the data traffic with the head-end router.
